(19) United States
(12) Patent Application Publication
(10) Pub. No.: US 2010/0052200 A1
(43) Pub. Date: Mar. 4, 2010

(54) Method For Porous Ceramic Honeycomb Shrinkage Reduction

(76) Inventors: Thomas James Deneka, Painted Post, NY (US); Nancy Ann Golomb, Corning, NY (US); Sandra Lee Gray, Horseheads, NY (US); Daniel Edward McCauley, Watkins Glen, NY (US); Patrick David Tepesch, Corning, NY (US); Christopher John Warren, Waverly, NY (US)

Correspondence Address: CORNING INCORPORATED, SP-TI-3-1, CORNING, NY, 14831, US

(21) Appl. No.: 12/395,005

(22) Filed: Feb. 27, 2009

Related U.S. Application Data
(60) Provisional application No. 61/067,733, filed on Feb. 29, 2008.

(51) Int. Cl. C04B 35/64

(52) U.S. Cl. 264/44; 264/630

(57) ABSTRACT

A method for reducing shrinkage variability of ceramic honeycombs formed from batch mixtures including inorganic materials and a pore former. X is a cumulative amount of pore former particles having a diameter less than 37 μm. There is a maximum value of X (Xmax) and a minimum value of X (Xmin) during a production period, and ΔX=Xmax−Xmin. The method fixes an amount of pore former fines such that X ranges from 25%-71% by volume, and ΔX is ≦23% throughout the production period.

### RELATED APPLICATIONS

This application claims the benefit of priority to U.S. Provisional Application No. 61/067,733 filed Feb. 29, 2008.

### FIELD

The invention relates to methods of manufacturing ceramic honeycombs.

### BACKGROUND

Recently much interest has been directed towards diesel engines due to their inherent fuel efficiency and durability. However, diesel emissions have been ascertained to be generally undesirable in the United States and Europe. Stricter environmental regulations will require diesel engines to meet higher emissions standards. Therefore, diesel engine manufacturers and emissions control companies are working to achieve diesel engines that are cleaner and meet the most stringent emission requirements under all operating conditions with minimal cost to the consumer.

One of the biggest challenges in lowering diesel emissions is controlling the levels of particulates present in the diesel exhaust system. Diesel particulates are mainly composed of carbon soot. One way of removing such soot from diesel exhausts is through the use of diesel filters. Ceramic Diesel Particulate Filters (DPFs) are widely used to filter exhaust gases from diesel engines, which occurs by capturing the soot on or in its porous walls.

Generally such DPFs include an arrangement of cell channels, at least some of which are plugged to force the engine exhaust to pass through the porous walls of the DPF. Such DPFs may include a catalyst coating, such as an oxidation or NOx catalyst, on their interior wall surfaces. A ceramic particulate filter is disclosed in U.S. Pat. No. 4,411,856, for example.

DPFs may be composed of aluminum titanate, cordierite, and silicon carbide, for example. Batch mixtures for forming porous ceramic honeycomb filters comprise, depending on the ceramic being formed, a mixture of: inorganic raw materials including, for example, sources of silica, alumina, magnesia, titania; and processing aids such as binders, pore formers and/or solvents.

Examples of batch materials for forming aluminum titanate honeycomb DPFs are disclosed in U.S. Pat. No. 7,259,120. An example of a batch mixture for forming a cordierite ceramic honeycomb is disclosed in U.S. Pat. Nos. 5,409,870; 7,141,089; 7,294,164; 7,309,371; and US Re 38,888. Batch materials for forming honeycombs have used various pore formers, for example, starches (e.g., corn, canna, sago, green mung bean and potato starch), flour, cellulose, graphite, amorphous carbon and synthetic polymers (e.g., polyethylene, polystyrene and polyacrylate).

The pore former is used to increase porosity and/or median pore size of the material used in making the honeycomb. Pore formers having various particle sizes and particle size distributions have been used in making DPFs (e.g., see U.S. Pat. No. 6,413,895). A published U.S. patent application Publication No. 2007/0119135 discloses DPF batch materials using starch pore former having a narrow particle size distribution, avoiding the use of graphite pore former due to problems of drying and firing attributed to it.

The ability to produce honeycombs that are extruded to shape (i.e., not machined to a final dimension) is dependant upon suitably controlling the variability in how much the filter shrinks (or grows) during the sintering or firing process. Filter contour specifications require careful control of the shrinkage of the extruded green honeycomb. Methods to control the extent of shrinkage variability in honeycomb include calcining and/or milling/comminuting of the batch raw materials to a defined particle size distribution prior to extrusion into the honeycomb structure. In silicon carbide honeycombs, altering the silicon content has been shown to affect the shrinkage behavior.

Accordingly, an effective way to minimize day-to-day shrinkage variability in the large scale production of honeycombs is desired such that relatively stringent filter contour specifications may be achieved.

### SUMMARY

According to a first embodiment, a method for reducing shrinkage variability of ceramic honeycombs, such as ceramic particulate filters is provided. A batch mixture is provided including inorganic materials and a pore former (and other processing aids). X is defined as a cumulative amount of particles in the pore former that are less than 37 μm (one micron being 1×10⁻⁶ meter). There is a maximum value of X (Xmax) and a minimum value of X (Xmin) during a production period, and ΔX=Xmax−Xmin. The inventive method fixes the amount of fines in the pore former such that X ranges from 25%-71% by volume and ΔX is ≦23% during the production period. The pore former in which the amount of fines are fixed in the first embodiment or which is selected in the second embodiment described below, is a pore former which has a significant limitation on the portion of fine particles. One such pore former is graphite. Other pore formers that may be suitable include walnut shell flour, rice starch, and corn starch, for example.

The ΔX range can be achieved in the following two ways. One aspect features analyzing the values of X for a plurality of lots of pore former to be used in the production period and staging an order of the lots based on the analysis such that the pore former is used in the batch mixtures so as to achieve the ΔX range throughout the production period. For example, pore former lots of various specifications of fines can be ordered or arranged so that their X values gradually increase or decrease during the production period, rather than fluctuate at random sometimes widely. A second aspect features specifying and analyzing all of the pore former used in the production period to ensure the pore former has a value of X limited to a range of from 30% by volume to 50% by volume.

In further aspects, X can range from about 30%-50% by volume and/or ΔX can be ≦17%. The method can include extruding green honeycombs made from the batch mixture and firing them to produce ceramic honeycombs adapted to be plugged so as to form the ceramic particulate filters having reduced shrinkage variability without machining. Shrinkage variability is referred to as a difference between a maximum value of % shrinkage of the filters during the period (Smax) and a minimum value of % shrinkage during the period (Smin). The shrinkage variability can be limited to ≦1%. The particle size distribution of pore former can vary in accordance with the inventive method, but in the first embodiment a suitable particle size distribution is characterized by the following features: d₁₀ is 10-14 μm, d₃₀ is 24-30 μm, d₅₀ is 38-50 μm and d₉₀ is 87-101 μm. The production period can be a time period in which at least 90,000 fired ceramic honeycombs are produced.

A second embodiment features a method for manufacturing a porous ceramic honeycomb. The method includes providing a batch mixture including inorganic materials and pore former (and other processing aids). The pore former is selected to remove fine particles (“fines”) such that an amount of pore former particles having a particle diameter of less than or equal to 5 μm is not greater than 10% of the total volume of the particle size distribution of pore former particles. In other embodiments, the amount of pore former particles having a particle diameter of less than or equal to 5 μm may be not greater than 5% by volume, or even not greater than 2% by volume. The method can include the steps of extruding (and drying) honeycombs made from the batch mixtures and firing the resulting honeycombs to produce ceramic honeycombs having shrinkage of not greater than 1%.

In particular, the pore former can be selected to have the following particle size distribution features:

d₁₀ ranging from 5.5 to 14 μm;

d₃₀ ranging from 15.1 to 27.9 μm;

d₅₀ ranging from 25.8 to 39.9 μm; and

d₉₀ ranging from 60 to 82.4 μm.

More specifically, the pore former is selected to have the following particle size distribution features:

d₁₀ ranging from 5.6 to 7.6 μm;

d₃₀ ranging from 17.7 to 20.2 μm;

d₅₀ ranging from 31.9 to 36.8 μm; and

d₉₀ ranging from 80 to 90 μm.

Yet even more specifically, the pore former is controlled, such as by air classification, to have the following particle diameter distribution features:

d₁₀ ranging from 25 to 26.5 μm;

d₃₀ ranging from 35 to 37 μm;

d₅₀ ranging from 52 to 56.9 μm; and

d₉₀ ranging from 85 to 95 μm.

There are numerous advantages of the embodiments disclosed herein. The day-to-day shrinkage variation of honeycombs can be substantially reduced by fixing the amount of fines in the pore former, thus reducing the level of products lost due to contour that is outside of specifications. This would result in fixed amounts of fine pores in the honeycomb that are susceptible to collapse. In addition, use of pore former having a fixed amount of fines might result in insignificant variation in physical properties compared to honeycombs made from conventional batch compositions. Moreover, the embodiments might permit using lower graphite pore former levels than in current batch mixtures for making aluminum titanate honeycombs. This would be advantageous because lower graphite levels in batch compositions have been shown to significantly improve drying characteristics of honeycombs. The embodiments do not require alteration of overall batch particle size distribution or composition to reduce shrinkage variability. Removing fines from the pore former enables honeycombs having reduced shrinkage to be produced. Extruded-to-shape honeycombs having reduced shrinkage are valuable in that there will be less variability in final product dimensions.

Many additional features, advantages and a fuller understanding of the invention as set forth in the claims will be had from the accompanying drawings and the detailed description that follows. It should be understood that the above Summary the following Detailed Description present embodiments that should not be construed as necessary elements or limitations.

### BRIEF DESCRIPTION OF THE DRAWINGS

FIG. 1 shows particle size distributions for “upper” and “lower” grades of graphite (14, 10, respectively) used as pore formers for making aluminum titanate honeycombs (these graphite grades being “extreme” compared to typical graphite grades), and a particle size distribution of a pore former 12

FIG. 2 is a graph showing a relationship between the amount by volume of graphite particles in a population of pore former particles less than 37 μm, and the major axis shrinkage of ceramic honeycombs.

FIG. 3 is a graph in which the X axis indicates sequential ceramic honeycombs analyzed and the Y axis indicates % shrinkage (or growth) of the honeycombs; graphite pore former being used in semi-random order in FIG. 3a, and in a staged order in FIG. 3b.

FIG. 4 is a graph showing % shrinkage of honeycombs as a function of d₁₀ values for graphite pore formers used in the batch mixture from which the honeycombs were made.

FIG. 5 shows particle size distributions of the graphite pore formers used to produce the data of FIGS. 4, 6, and 7.

FIG. 6 is a graph showing % shrinkage of honeycombs as a function of d₅₀ values for graphite pore formers used in the batch mixture from which the honeycombs were made.

FIG. 7 is a graph showing % shrinkage of honeycombs as a function of d₉₀ values for graphite pore formers used in the batch mixture from which the honeycombs were made.

### DETAILED DESCRIPTION

A first embodiment features a method for reducing shrinkage variability of ceramic honeycombs using a batch mixture in which graphite is used as all or part of the pore former. The pore former in which the amount of fines was fixed consisted essentially of graphite. Other pore formers in which the amount of fines are fixed may be used instead of or in addition to graphite as will be appreciated by those skilled in the art in view of this disclosure. X is defined herein as a cumulative amount (in % by volume) of graphite particles in the population of pore former particles that are less than 37 μm. There is a maximum value of X (Xmax) and a minimum value of X (Xmin) during a production period in which fired ceramic honeycombs are made, and ΔX=Xmax−Xmin. In this method the amount of graphite fines in the population of graphite pore former particles is fixed such that X ranges from 25%-71% by volume and ΔX is ≦23% during the production period. In a particular aspect, X ranges from about 30%-50% by volume and/or ΔX≦17%. For improving understanding a production period can be described as a period during which, for example, at least 90,000 fired ceramic honeycombs are produced. The production period can vary from this exemplary period as known by those of ordinary skill in the art in view of this disclosure.

Regarding the meaning of certain terms used in this disclosure, “pore former” as used herein is defined as a fugitive particulate material which evaporates or undergoes vaporization by combustion during drying or heating of the green body to obtain a desired, usually larger porosity and/or coarser median pore diameter than would be obtained otherwise without the pore former. In the relation X, the amount (% by volume) of graphite particles in the population of graphite pore former particles less than 37 μm, particle size is based on equivalent spherical diameter. In the first embodiment, the “fines” in the pore former are particles that are less than 37 μm in equivalent spherical diameter. All particle size measurements in this disclosure were made by laser diffraction using a Microtrac Model S3500 particle analyzer. The graphite samples were prepared by adding 0.1 g of sample directly to circulating water in a sample port and dispersing with 2 drops of a 5% Triton X solution.

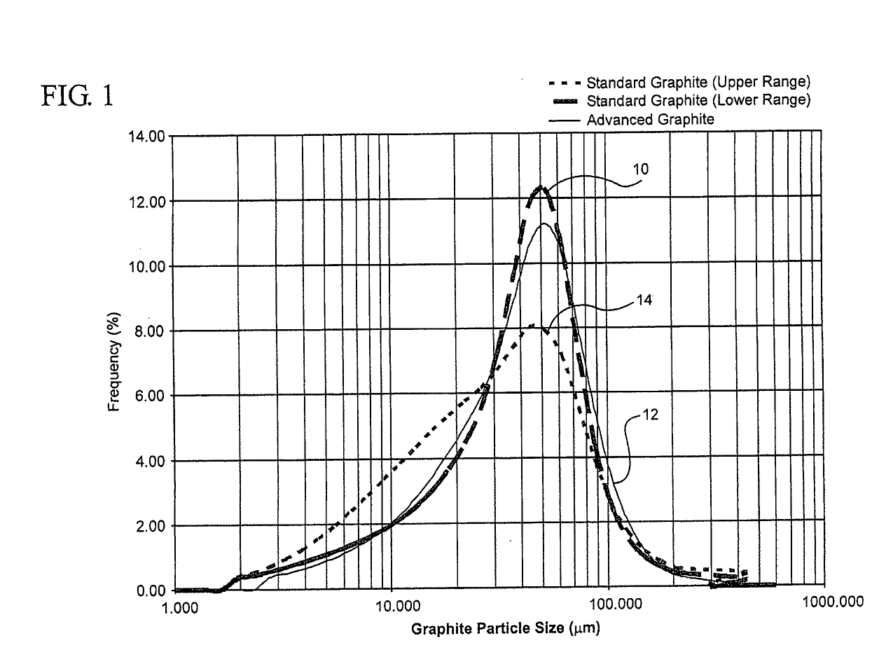

Different particle size distributions of graphite pore former for making ceramic particulate filters are shown in FIG. 1. FIG. 1 shows significant variability in the population of fines in “upper and lower range” extremes of production grades of graphite pore former. The upper and lower range grades represent the outer limits in variability of d₃₀ values seen in production grades. Both the “lower range” curve 10 and the curve 12 of a material suitable for use, had a d₃₀ value of about 26 μm and a value of X of about 42% by volume. That is, 30% by volume of the graphite pore former particles had a particle size of less than 26 μm; and about 42% by volume of graphite particles in the population of graphite pore former particles had a particle size less than 37 μm. The “upper range” curve 14 had a d₃₀ value of about 16 μm and a value X of about 68% by volume.

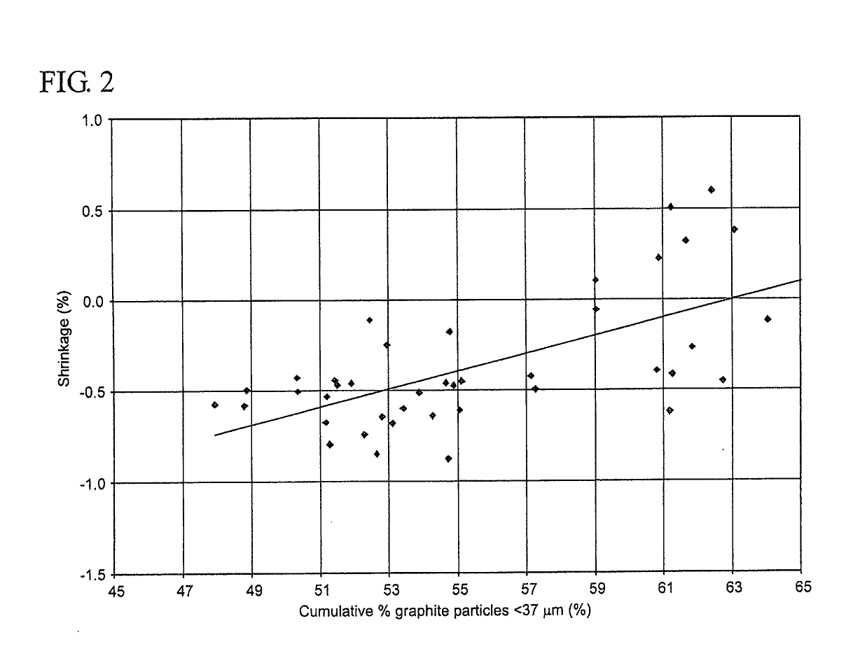

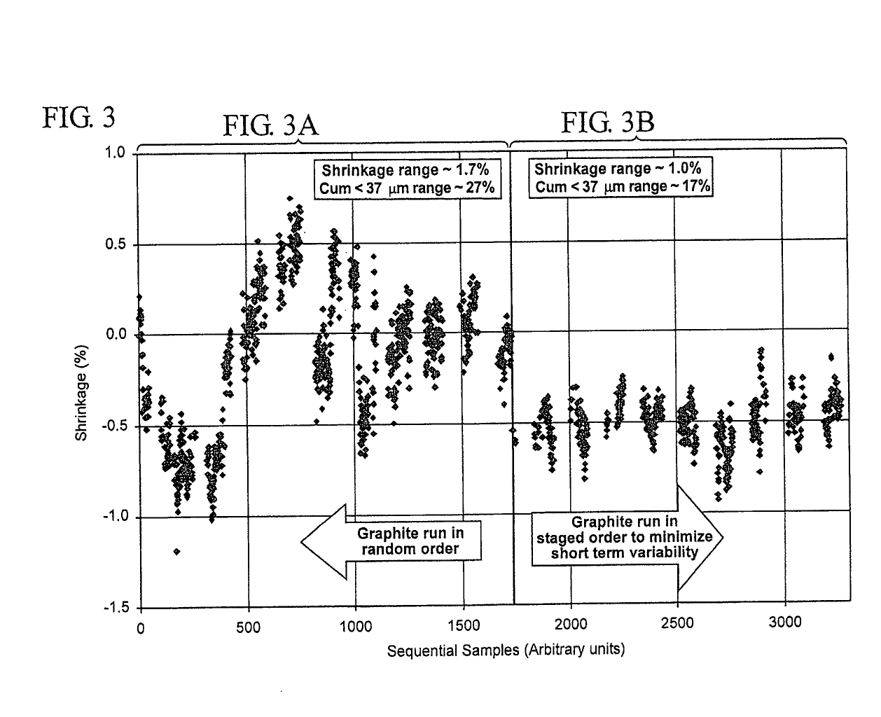

FIG. 2 shows that the shrinkage of ceramic honeycombs is influenced by the value of X, the amount (in % by volume) of the population of graphite pore former particles that is less than 37 μm. While the shrinkage of ceramic honeycombs can be influenced by various factors, for example, raw materials and various extrusion parameters, these other factors were not controlled in the historical data used to produce FIGS. 2 and 3. The data in FIGS. 2 and 3a are from production periods (6 months in FIG. 2) in which ceramic honeycombs were manufactured using batch materials that included graphite pore formers of numerous lots, including the upper and lower range graphite materials shown in FIG. 1 as well as many standard graphite grades having d₃₀ values between the d₃₀ values of the upper and lower range materials in FIG. 1.

A correlation between the amount of graphite particles less than 37 μm in the graphite pore former and the major axis shrinkage of aluminum titanate ceramic honeycombs produced therefrom, was generated. The line in FIG. 2 is a linear regression fit for the data and shows that as the % by volume of the population of graphite particles below 37 μm increases, so does the shrinkage of the ceramic honeycombs, which is undesirable. Therefore, the inventive method ensures that the difference between Xmax and Xmin is not more than 23% and in particular is not more than 17% during the production period as this reduces shrinkage variability. Rather than seeking to eliminate either fines or large particles in the graphite pore former or the batch composition, the first embodiment fixes the amount of such fines and variations in such amounts, thereby reducing the variability in shrinkage of the honeycombs produced using them.

A program was established to stage grades of graphite pore former so as to minimize the short term rate of shrinkage fluctuations of ceramic honeycombs due to the graphite pore former being used in production in a semi-random order. FIG. 3 shows the impact of this staging program, which examined shrinkage of ceramic honeycombs made in production. FIG. 3a shows the shrinkage of ceramic honeycombs when the graphite pore former lots were used in the batch materials in a semi-random order and the resulting green honeycombs were fired. FIG. 3b shows reduced shrinkage variability of ceramic honeycombs when the graphite pore-former lots were pre-analyzed and used in batch mixtures in a staged order and the resulting green honeycombs were fired.

In FIG. 3a, Xmax was 71% by volume and Xmin was 44% by volume during the production period, the difference or range between them being 27%. This produced a 1.7% shrinkage variability. In FIG. 3b, Xmax was 64% by volume and Xmin was 47% by volume during the production period, the difference or range between them being 17%. This produced a 1% shrinkage variability. When the graphite pore former lots were used in a semi-random order the shrinkage variability range was higher (about 1.7%, as shown in FIG. 3a), compared to when the graphite pore former lots were controlled in a staged order to achieve a ΔX range of not more than 17%, resulting in reduced shrinkage variability (about 1%, as shown in FIG. 3b). The graphite pore former lots were controlled in FIG. 3b by analyzing the amount of fines in the pore former for each of a plurality of lots of the pore former to be used in the production period (having non-specified values of X) and then staging an order in which the graphite pore former lots were used in batch mixtures so as to achieve ΔX of about 17% throughout the 9 week production period.

The data presented in FIG. 3 represent only one example of the number of honeycombs that can be made during production. The production periods shown are arbitrary and simply shows that data of FIG. 3a for that production period as compared to the data of FIG. 3b for a comparative production period. The data of FIG. 3 is from a production lot in which green honeycombs were produced resulting in a number of fired honeycombs (ceramic honeycombs) during the production period of at least about 90,000.

Another aspect of the method features specifying and analyzing all of the graphite pore former used in the production period to ensure a value of X limited to a range of from 30% by volume to 50% by volume. For example, samples of graphite pore former lots received from the supplier at a specification in which X ranges from 30-50% by volume, are pre-analyzed using laser diffraction to ensure that all of the pore former using during the production period has X values in this range. This might be used with the staging procedure.

The advantages described herein are not limited to a particular batch mixture for forming honeycombs. The advantages apply to batch mixtures having inorganic source material with which the pore former can be suitably used. The data of FIGS. 2 and 3 used batch mixtures for making ceramic honeycombs having a predominantly aluminum titanate phase, but the instant disclosure also applies to batch mixtures for making honeycombs of cordierite or other ceramics, which can employ suitable (e.g., graphite) pore former.

The graphite pore former in the first embodiment may have the particle diameter distribution features A, B or C of Table 1 with particle size distribution features C being especially suitable.

TABLE 1

| Distribution | d₁₀ (μm)* | d₃₀ (μm) | d₅₀ (μm) | d₉₀ (μm) |
|---|---|---|---|---|
| A | 4-16 | 16-34 | 24-54 | 60-105 |
| B | 8-16 | 20-34 | 34-54 | 83-105 |
| C | 10-14 | 24-30 | 38-50 | 87-101 |

*Values of dₙ mean n % by volume of the distribution of graphite pore former particles is less than the particle diameter given. For example, in the particle size distribution feature C, value d₃₀ of 24 μm means that 30% by volume of the distribution of graphite pore former particles have a particle diameter less than 24 μm.

A suitable batch composition includes inorganic materials, the pore former having the fixed fines as described herein (or removed fines as discussed in the second embodiment below), and other compounds including processing aids. The graphite pore former having fixed fines as specified herein can be supplied by Asbury Graphite Mills, Inc. using suitable feedstock and reducing particle size in a roller mill. A suitable batch composition for making aluminum titanate honeycombs is disclosed in the U.S. Pat. No. 7,259,120 patent, but using the graphite pore formers described in this disclosure. The batch composition is formed into a plastic mass that is extruded through a die to form “wet” honeycombs having a honeycomb structure with suitable cell density, wall thickness and outer peripheral dimensions in cross section. The wet honeycombs are dried, forming “green” honeycombs which are fired (i.e., sintered) in a furnace at a temperature suitable to form ceramic honeycombs having the desired predominant ceramic phase. The ceramic honeycombs were not machined to produce the final dimensions but were extruded to shape taking into account expected target shrinkage.

The % shrinkage and shrinkage variability referred to in this disclosure are based on the major axis shrinkage of the honeycombs measured between the green and fired stages of the honeycombs. The ceramic honeycombs would then be plugged to form ceramic particulate filters having substantially the same shrinkage variability and shrinkage as what was measured for the ceramic honeycombs. Shrinkage variability is defined as a maximum value of % shrinkage of the filters produced during the production period (Smax) minus a minimum value of % shrinkage of the filters produced during the period (Smin), the shrinkage variability may be ≦1%.

The second embodiment features a method for manufacturing a porous ceramic honeycomb. The method includes providing a batch mixture including inorganic source materials and pore former. The pore former is selected, which includes being modified to remove fines, such that an amount of pore former particles having a particle diameter of less than or equal to 5 μm is not greater than 10% of the total volume of the distribution of pore former particles. Further, the amount of pore former particles having a particle diameter less than or equal to 5 μm may be not greater than 5% by volume, or even not greater than 2% by volume.

The data of FIGS. 2, 3 and 4 was obtained using batch mixtures including a combination of potato starch pore former, which was not controlled in accordance with the instant disclosure, with graphite pore former (which was) in an about equal parts based on the amount of inorganic source material in the batch composition. Pore former that can be selected, such as by being modified or classified, sifted or sieved, is a pore former which has a significant amount of fines including, but not limited to, walnut shell flour, rice starch, and corn starch pore formers, for example.

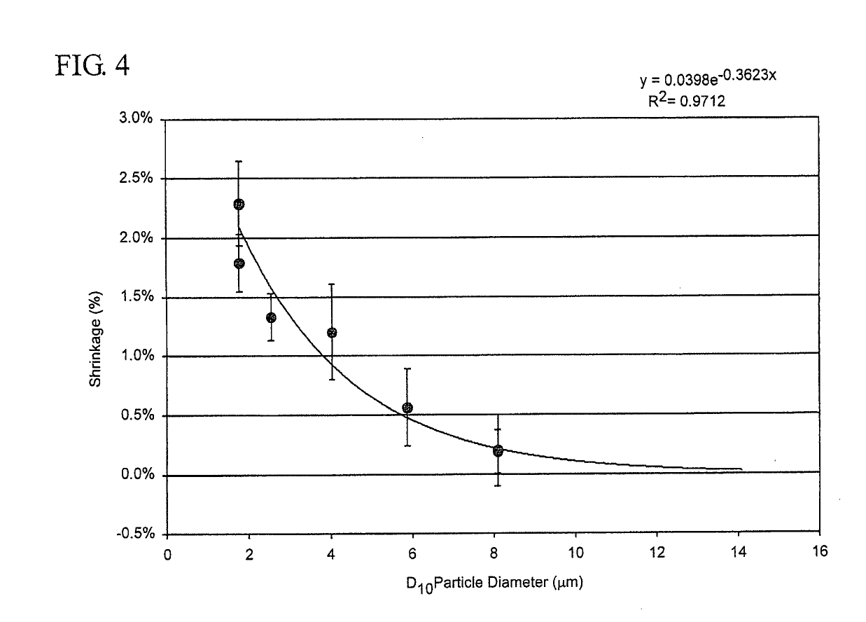

Referring to FIG. 4, there is a correlation between shrinkage of ceramic honeycombs and the amount of fines in the pore former based on d₁₀ values. Using the indicated exponential best fit function a line was drawn in FIG. 4, resulting in a high least squares fit of R²=0.97. The green-to-fired shrinkages of honeycombs made from batch material with pore-formers having d₁₀ values of about 4 μm, about 6 μm and about 8 μm was about 1.2%, 0.56% and 0.19%, respectively. FIG. 4 shows that using pore former that is selected to have d₁₀ values of at least 4 μm, advantageously results in % shrinkage of less than or equal to about 1%.

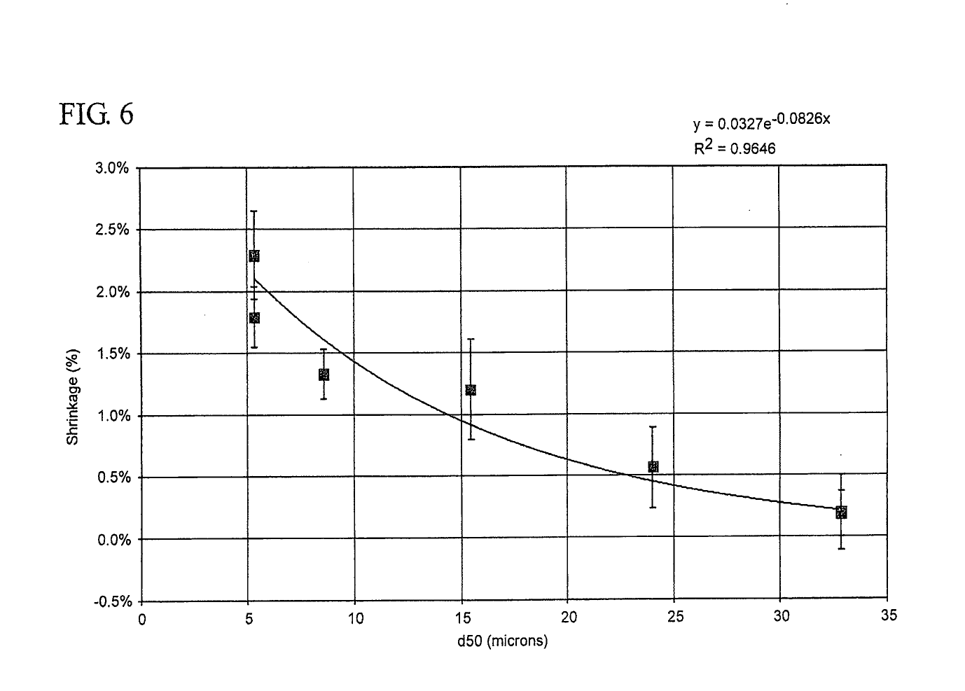

Referring to FIG. 6, there is a correlation between shrinkage of ceramic honeycombs and the amount of fines in the pore former based on d₅₀ values. Using the indicated exponential best fit function a line was drawn in FIG. 6, resulting in a high least squares fit of R²=0.96. The green-to-fired shrinkages of honeycombs made from batch material with pore-formers having d₅₀ values of about 15 μm, about 24 μm and about 33 μm was about 1.2%, 0.56% and 0.19%, respectively. FIG. 6 shows that using pore former that is selected to have d₅₀ values of at least 15 μm, advantageously results in % shrinkage of less than or equal to about 1%.

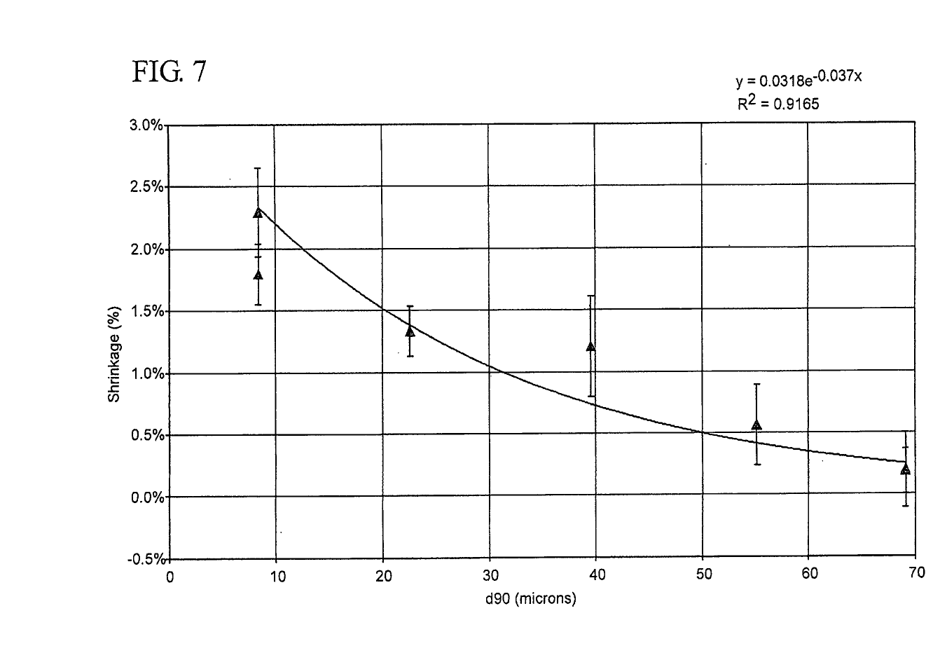

Referring to FIG. 7, there is a correlation between shrinkage of ceramic honeycombs and the amount of fines in the pore former based on d₉₀ values. Using the indicated exponential best fit function a line was drawn in FIG. 7, resulting in a high least squares fit of R²=0.92. The green-to-fired shrinkages of honeycombs made from batch material with pore-formers having d₉₀ values of about 40 μm, about 55 μm and about 70 μm was about 1.2%, 0.56% and 0.19%, respectively. FIG. 7 shows that using pore former that is selected to have d₉₀ values of at least 40 μm, advantageously results in % shrinkage of less than or equal to about 1%.

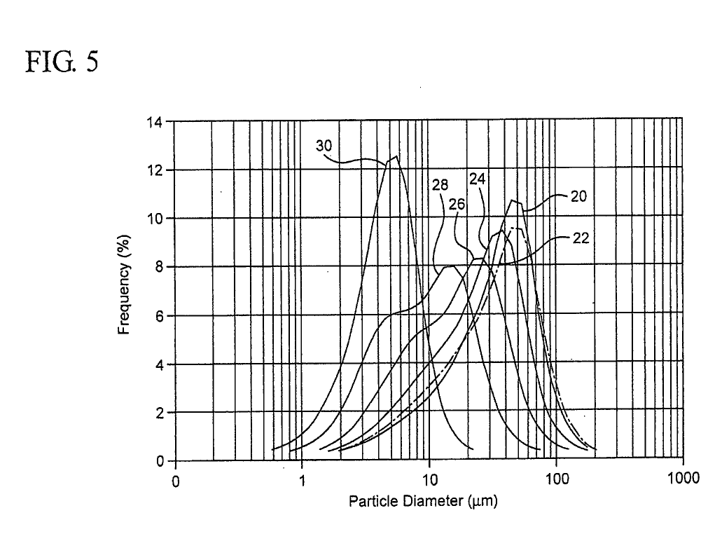

FIG. 5 shows particle size distributions of the graphite pore formers used to produce the % shrinkages of honeycombs shown in FIG. 4. Curve 22 in FIG. 5 was a control and no datapoints correspond to it in FIG. 4. The two datapoints in FIG. 4 at d₁₀ of about 8 μm were both obtained using graphite pore former having the distribution curve 20. The datapoint at d₁₀ of about 6 μm was obtained using graphite pore former having distribution curve 24. The datapoint at d₁₀ of about 4 μm was obtained using graphite pore former having distribution curve 26. The next datapoint to the left at d₁₀ of above 2 μm was obtained using graphite pore former having distribution curve 28. The two datapoints at the lowest d₁₀ values below 2 μm were both obtained using graphite pore former having distribution curve 30.

The pore former can be selected to achieve the particle size distribution characteristics 1, 2 or 3, and associated d₁₀, d₃₀, d₅₀ and d₉₀ values, shown in the following Table 2. Particle size distribution characteristics 1 and 2 and ranges were derived from samples of graphite pore former. Better properties are expected to be achieved using particle size distribution characteristics in ascending order of 1-3. The particle size characteristics 3 are an estimation of what might be achieved by air classifying material having particle size distribution characteristics 2. Air classification of graphite may be carried out by Asbury Graphite Mills, Inc.

TABLE 2
Particle Diameters

| | | Samples | Samples | Estimate |
|---|---|---|---|---|
| | | 1 | 2 | 3 |
| d₁₀ | Min | 5.5 | 5.6 | 25 |
| | Max | 14 | 7.6 | 26.5 |
| | Range | 8.5 | 2.0 | 1.5 |
| d₃₀ | Min | 15.1 | 17.7 | 35 |
| | Max | 27.9 | 20.2 | 37 |
| | Range | 12.8 | 2.5 | 2.0 |
| d₅₀ | Min | 25.8 | 31.9 | 52 |
| | Max | 39.9 | 36.8 | 56.9 |
| | Range | 14.1 | 4.9 | 4.9 |
| d₉₀ | Min | 60 | 80 | 85 |
| | Max | 82.4 | 90 | 95 |
| | Range | 22.4 | 10.0 | 10.0 |

According to the data in Table 2, the pore former may be selected to provide d₁₀ to be greater than 3 μm, more preferably in the range of 3 μm to 35 μm, and most preferably between 5 μm and 27 μm. In addition, the pore former may be selected to provide d₅₀ to be in the range of 15 μm to 70 μm, more preferably in the range of 20 μm to 65 μm, and most preferably between 25 μm and 57 μm. In addition, the pore former may be selected to provide d₉₀ to be less than 125 μm, more preferably 60 μm to 120 μm, and most preferably 80 μm to 110 μm.

Many modifications and variations of the embodiments described herein will be apparent to those of ordinary skill in the art in light of the foregoing disclosure.

What is claimed is:

1. A method for reducing shrinkage variability of ceramic honeycombs formed from batch mixtures including inorganic materials and pore former, wherein X is a cumulative amount of particles in said pore former less than 37 μm equivalent spherical diameter, there is a maximum value of X (Xmax) and a minimum value of X (Xmin) during a production period, and ΔX=Xmax−Xmin, comprising:
fixing an amount of fines in said pore former such that X ranges from 25%-71% by volume and ΔX is ≦23% throughout said production period.

2. The method of claim 1 wherein ΔX≦17%.

3. The method of claim 1 wherein X ranges from about 30%-50% by volume.

4. The method of claim 3 wherein ΔX≦17%.

5. The method of claim 1 comprising analyzing the values of X for a plurality of lots of pore former to be used in said production period and staging an order of said lots based on said analysis such that said pore former is used in said batch mixtures so as to achieve said ΔX throughout said production period.

6. The method of claim 1 comprising specifying and analyzing all pore former used in the production period to ensure the pore former has a value of X limited to a range of from 30% by volume to 50% by volume.

7. The method of claim 1 comprising extruding green honeycombs made from said batch mixtures and firing to produce ceramic honeycombs adapted to be plugged so as to produce ceramic particulate filters having reduced shrinkage variability without machining.

8. The method of claim 7 wherein said shrinkage variability is a difference between a maximum value of % shrinkage of said honeycombs during said period (Smax) and a minimum value of % shrinkage during said period (Smin), said shrinkage variability being controlled to be ≦1%.

9. The method of claim 1 wherein the particle size distribution of said pore former is characterized by the following features:
d₁₀ is 10-14 μm,
d₃₀ is 24-30 μm,
d₅₀ is 38-50 μm, and
d₉₀ is 87-101 μm.

10. The method of claim 7 wherein said production period is a time period in which at least 90,000 of said ceramic honeycombs are produced.

11. The method of claim 1 wherein said pore former in which said fines are fixed is graphite pore former.

12. A method for manufacturing a porous ceramic honeycomb, comprising the steps of:
providing a batch mixture including inorganic materials and pore former having a particle size distribution; and
selecting the pore former such that an amount of pore former particles having a particle diameter less than or equal to 5 μm is not greater than 10% of the total volume of the particle size distribution.

13. The method of claim 12 wherein said pore former is a graphite pore former.

14. The method of claim 12 wherein the amount of pore former particles having a particle diameter of less than or equal to 5 μm is not greater than 5% of the total volume of the distribution.

15. The method of claim 12 wherein the amount of pore former having a particle diameter of less than or equal to 5 μm is not greater than 2% of the total volume of the distribution.

16. The method of claim 12 comprising
extruding a green honeycomb from said batch mixture; and
firing said green honeycomb to produce a ceramic honeycomb having a shrinkage of not greater than 1%.

17. The method of claim 12 comprising selecting said pore former to have the following particle size distribution features:
d10 ranging from 5.5 μm to 14 μm;
d30 ranging from 15.1 μm to 27.9 μm;
d50 ranging from 25.8 μm to 39.9 μm; and
d90 ranging from 60 μm to 82.4 μm.

18. The method of claim 12 comprising selecting said pore former to have the following particle size distribution features:
d10 ranging from 5.6 μm to 7.6 μm;
d30 ranging from 17.7 μm to 20.2 μm;
d50 ranging from 31.9 μm to 36.8 μm; and
d90 ranging from 80 μm to 90 μm.

19. The method of claim 12 comprising selecting said pore former to have the following particle size distribution features:
d10 ranging from 25 μm to 26.5 μm;
d30 ranging from 35 μm to 37 μm;
d50 ranging from 52 μm to 56.9 μm; and
d90 ranging from 85 μm to 95 μm.

20. The method of claim 19 wherein said selecting includes the step of air classifying said pore former.
